(19) United States
(12) Patent Application Publication
(10) Pub. No.: US 2008/0024408 A1
(43) Pub. Date: Jan. 31, 2008

(54) SYSTEMS FOR DISPLAYING IMAGES AND DRIVING METHOD THEREOF

(75) Inventors: Keiichi Sano, Taipei City (TW); Wei-Cheng Lin, Kaohsiung City (TW); Chi-Fu Wu, Miaoli County (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: TPO DISPLAYS CORP., Miao-Li County (TW)

(21) Appl. No.: 11/459,656

(22) Filed: Jul. 25, 2006

(51) Int. Cl. G09G 3/36

(52) U.S. Cl. 345/88

(57) ABSTRACT

Systems for displaying images. The system comprises a display panel comprising a plurality of data lines DL(x), a plurality of gate lines SL(y) perpendicular to the data lines DL(x), and a pixel array coupled to the data lines and the gate lines. The pixel array comprises a first pixel P(x+1, y) coupled to the gate line SL(y+1) and the data line DL(x+1), a second pixel P(x+1, y+1) coupled to the gate line SL(y+1) and the data line DL(x+2), a third pixel P(x, y+1) coupled to the gate line SL(y+2) and the data line DL(x+1), and a fourth pixel P(x, y+2) coupled to the gate line SL(y+2) and the data line DL(x).

### BACKGROUND OF THE INVENTION

1.Field of the Invention

The invention relates to the display of images.

2.Description of the Related Art

Liquid crystal displays (LCDs) are used in a variety of applications including calculators, watches, color televisions, computer monitors, and many other electronic devices. Active matrix LCDs are a well known type of LCD. In a conventional active matrix LCD, each picture element (or pixel) is addressed using a matrix of thin film transistors (TFT) and one or more capacitors. The pixels are arranged and wired in an array having a plurality of rows and columns. For example, a SVGA display is a matrix of 2400×600 pixels.

To address a particular pixel, the proper row is switched “on” (i.e., charged with a voltage), and a voltage is sent down the correct column. Since other intersecting rows are turned off, only the TFT and capacitor at the particular pixel receive a charge. In response to the applied voltage, the liquid crystal cell of the pixel changes its polarization, and thus, the amount of light reflected therefrom or passing therethrough. This process is then repeated row by row.

In liquid crystal cells of a pixel, the magnitude of applied voltage determines the amount of light reflected therefrom or passing therethorugh. Due to the nature of liquid crystal material, the polarity of the voltage applied across the liquid crystal cell must alternate. Therefore, for an LCD displaying video, the voltage polarity of the liquid crystal cells is inverted (or reversed) for alternate frames of the video. This process is known as inversion.

Unfortunately, if the polarity of the entire LCD is inverted with the same polarity for alternate frames, the LCD flickers at an unacceptable level. Hence, many conventional LCDs use other forms of inversion, such as line inversion or dot inversion. In line inversion, alternate columns or rows of an LCD are inverted on alternate frames (e.g., in a “striped” pattern). Dot inversion inverts alternate pixels of each row and column alternate frames (e.g., in a “checkerboard” pattern). Of the two inversion techniques, dot inversion is generally considered to produce higher display quality.

However, inversion, especially dot inversion, increases power consumption of the LCD, since the data lines behave as a capacitive load (and may also include a storage capacitor), and thus, consume power as their voltages change polarity. Since LCDs are often used in battery powered or low power devices, many LCDs use driving methods optimized for power consumption. For example, many LCDs use line inversion rather than dot inversion.

### BRIEF SUMMARY OF THE INVENTION

A detailed description is given in the following embodiments with reference to the accompanying drawings.

Embodiments of a system displaying images are provided, comprising a display panel. The display panel comprises a plurality of data lines DL(x), a plurality of gate lines SL(y) perpendicular to the data lines DL(x), and a pixel array coupled to the data lines and the gate lines. The pixel array comprises a first pixel P(x+1, y) coupled to the gate line SL(y+1) and the data line DL(x+1), a second pixel P(x+1, y+1) coupled to the gate line SL(y+1) and the data line DL(x+2), a third pixel P(x, y+1) coupled to the gate line SL(y+2) and the data line DL(x+1), and a fourth pixel P(x, y+2) coupled to the gate line SL(y+2) and the data line DL(x). For example, x, y can be positive integers.

The invention provides another embodiment of a system displaying images, comprising a display panel. The display panel comprises first and second data lines, a first gate line perpendicular to the first and second data lines, and first and second pixels disposed in the same column to display the same color. The first and second pixels are both coupled to the first gate line and receive display data on the first and second data lines respectively.

The invention provides an embodiment of a driving method of a system displaying images, in which gate lines are scanned in sequence and display data is provided to data lines in an effective display period in a frame period based on column inversion. The data lines are electrically coupled to a common voltage in a blanking period of the frame period, wherein the ratio of the blanking period to the frame period exceeds 5%.

### BRIEF DESCRIPTION OF THE DRAWINGS

The invention can be more fully understood by reading the subsequent detailed description and examples with references made to the accompanying drawings, wherein:

FIG. 1 is a diagram illustrating a display panel known to the inventors.

FIG. 2 shows an embodiment of a system displaying images incorporating a display panel;

FIG. 3 shows a driving method of the system for displaying images; and

FIG. 4 shows another embodiment of a system for displaying images.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

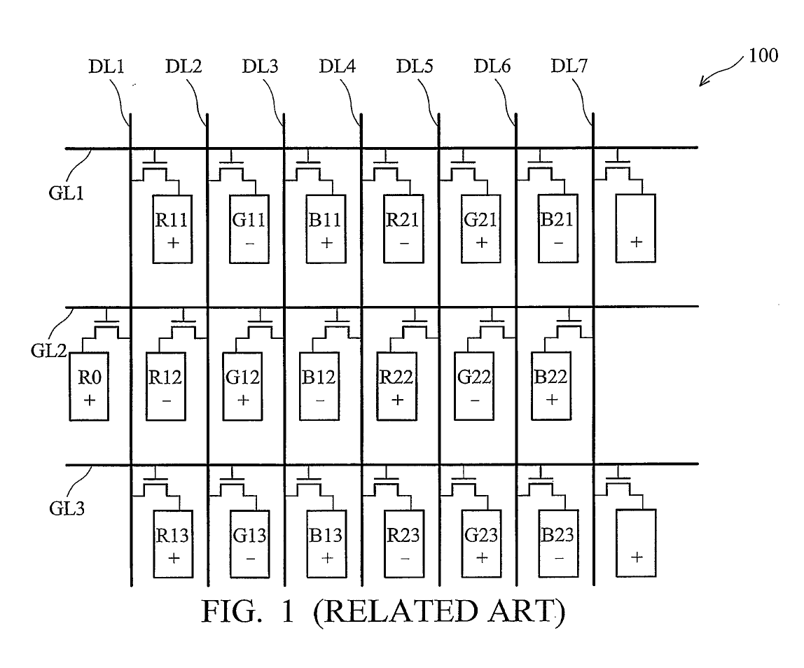

FIG. 1 demonstrates a display panel known to the inventors for displaying images. This is not prior art for purposes of determining the patentability of the invention and merely shows a problem found by the inventors.

As shown in FIG. 1, the display panel 100 is driven by a column inversion, but can obtain display quality as driven by a dot inversion due to pixel layout thereof. For example, the odd-numbered data lines and even-numbered data lines are provided by display data with two different polarities in each frame, and the polarities are switched frame by frame. The display panel 100 can be driven by column inversion to obtain display quality as driven by dot inversion, because the pixels in the second row, coupled to the gate line GL2, are each coupled to the data line disposed on the right side thereof and those coupled to the gate lines GL1 and GL3 are coupled to the data lines disposed on the left side thereof.

As each gate line, such as GL1, is activated, display data of different polarities on data lines DL1, DL2, DL3, . . . , DL6 is input to the pixels R11, G11, B11, R21, G21, B21. However, due to coupling effect, each pixel is affected by display data on adjacent data lines. For example, the pixel R11 is driven by the display data with a positive polarity on the data line DL1 and affected by the display data with a negative polarity on the adjacent data line DL2. The pixel G11 is driven by the display data with a negative polarity on the data line DL2 and affected by the display data with a positive polarity on the adjacent data line DL3, and so on. Thus, the pixels cannot remain at the desired voltage level due to the display data on the adjacent data line, referred to coupling noise. Low coupling noise induces effects upon each pixel because different color pixels have different driving voltage. For example, coupled noise caused by the display data with a negative polarity on the adjacent data line DL2 has a great effect on the pixel R11, and so on. Because of this, brightness of pixels occurs with the lower area of the panel more serious for bright/dark line defect than the upper portion.

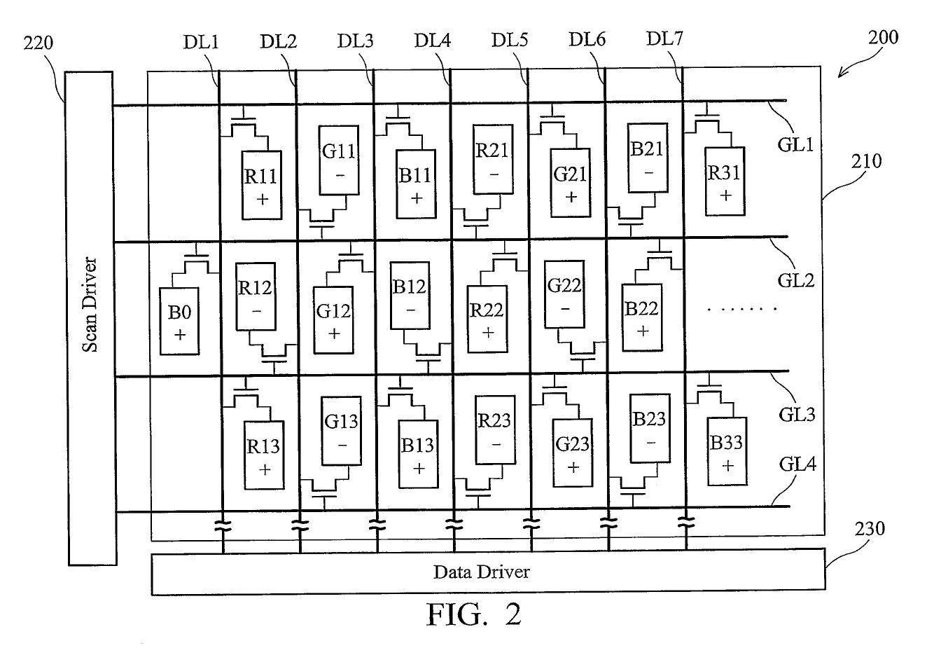

FIG. 2 shows an embodiment of a system for displaying images that includes a display panel. As shown, the display panel 200 comprises a pixel array 210, a scan driver 220 and a data driver 230. The pixel array 210 comprises a plurality of data lines DL1, DL2, DL3, . . . , coupled to the data driver 220, a plurality of gate lines GL1, GL2, GL3, . . . , coupled to the scan driver 230, and a plurality of pixels.

The data line DL1 is coupled to the pixels R11, B0, and R13, the data line DL2 is coupled to the pixels G11, R12, and G13, and the data line DL3 is coupled to the pixels B11, G12, and B13. The data line DL4 is coupled to the pixels R21, B12, and R23, the data line DL5 is coupled to the pixels G21, R22, and G23, and the data line DL6 is coupled to the pixels B21, G22, and B23. The data line DL7 is coupled to the pixels R31, B22, and R33, and so on.

The gate line GLI is coupled to the pixels R11, B11, G21, B31 and so on. The gate line GL2 is coupled to the pixels B0, G11, G12, R21, R22, B21, B22 and so on. The gate line GL3 is coupled to the pixels R12, R13, B12, B13, G22, G23, B33 and so on. The gate line GL4 is coupled to the pixels G13, R23, B23 and so on.

Namely, the gate line GL2 is coupled to a pair of pixels G11 and G12 displaying green color, a pair of pixels R21 and R22 displaying red color, and a pair of pixels B21 and B22 displaying blue color. The gate line GL3 is coupled to a pair of pixels R12 and R13 displaying red color, a pair of pixels B12 and B13 displaying blue color and a pair of pixels G22 and G23 displaying green color, and so on.

To obtain display quality as driven by dot inversion, the display panel 200 is driven by column inversion.

For example, in a current frame (as shown in FIG. 2), the scan driver scans the gate lines, GL1, GL2, GL3 and GL4 in sequence, while the data driver provides positive polarity display data on the odd-numbered data lines DL1, DL3, DL5 and GL7 and negative polarity display data on the even-numbered data lines DL2, DL4 and DL6. In the following frame (not shown), the scan driver scans the gate lines GL1, GL2, GL3 and GL4 in sequence, while the data driver provide negative polarity display data on the odd-numbered data lines DL1, DL3, DL5 and GL7 and positive polarity display data on the even-numbered data lines DL2, DL4 and DL6.

In the embodiment, when one gate line is scanned, pixels disposed on two sides of each driven gate line are not driven. For example, if gate line GL1 is scanned by the scan driver 220, the pixels R11, B11, G21 and R31 are driven and the pixels G11, R21, B21 are not. As the gate line GL2 is scanned by the scan driver 220, the pixels B0, G11, G12, R21, R22, B21 and B22 are driven and the pixels R12, B12, G22 are not. As the gate line GL3 is scanned by the scan driver 220, the pixels R12, R13, B12, B13, G22, G23 and B33 are driven, and pixels B0, G12, G13, R22, R23, B22 and B23 are not driven, and so on.

Because each driven pixel and pixels disposed on two sides thereof are not driven at the same time, display data for the other color from adjacent data lines does not affect the driven pixel, and thus coupled noise and bright/dart line defect can be reduced.

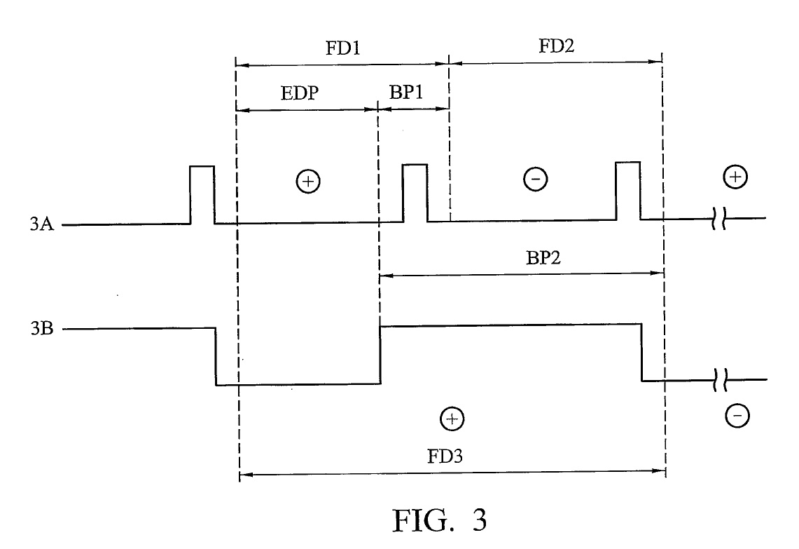

FIG. 3 shows a driving method of the system for displaying images. As shown, the wave 3A illustrates the display panel 200 is driven by column inversion. In an effective display period EDP of the frame period FD1, the scan driver 220 scans all gate lines, such as GL1, GL2, GL3 and GL4, in sequence, while the data driver 230 provides positive polarity display data on the odd-numbered data lines DL1, DL3, DL5 and GL7 and negative polarity display data on the even-numbered data lines DL2, DL4 and DL6. Next, in a blanking period BP1, all data lines, DL1, DL2, DL3 and . . . , are coupled to a common voltage (not shown), wherein the frame rate of the display panel 200 is 60 Hz.

In the effective display period of the frame period FD2, the scan driver 220 scans the all gate lines, such as GL1, GL2, GL3 and . . . , in sequence, while the data driver 230 provides negative polarity display data on the odd-numbered data lines DL1, DL3, DL5 and GL7 and positive polarity display data on the even-numbered data lines DL2, DL4 and DL6. Next, in the blanking period BP1, all data lines, DL1, DL2, DL3 and . . . , are coupled to the common voltage (not shown), wherein the ratio of the blanking period BP1 to the frame period FD1 or FD2 exceeds 5%.

As shown, the wave 3B illustrates the display panel 200 driven by column inversion, in which the blanking period BP1 is extended to half frame period FD3 such that the frame rate is lower to 30 Hz. In an effective display period EDP of the frame period FD1, the scan driver 220 scans all gate lines, such as GL1, GL2, GL3 and GL4, in sequence, while the data driver 230 provides positive polarity display data on the odd-numbered data lines DL1, DL3, DL5 and GL7 and negative polarity display data on the even-numbered data lines DL2, DL4 and DL6. Next, in a blanking period BP2, all data lines, DL1, DL2, DL3 and . . . , are coupled to a common voltage (not shown).

In the effective display period of the frame period FD2, the scan driver 220 scans the all gate lines, such as GL1, GL2, GL3 and . . . , in sequence, while the data driver 230 provides negative polarity display data on the odd-numbered data lines DL1, DL3, DL5 and GL7 and positive polarity display data on the even-numbered data lines DL2, DL4 and DL6. Next, in the blanking period BP1, all data lines, DL1, DL2, DL3 and . . . , are coupled to the common voltage (not shown).

TABLE 1
shows

| | | | Frame rate at 30 Hz | |
|---|---|---|---|---|
| | | | with blanking period | |
| | Frame rate at 60 Hz | | half frame period | |
| | | New | | New |
| | Old structure | structure | Old structure | structure |
| Upper area on | ~4 mV | ~44 mV | ~26 mV | ~22 mV |
| panel | | | | |
| Center area on | ~48 mV | ~0 mV | ~48 mV | ~0 |
| panel | | | | |
| Lower area on | ~91 mV | ~44 mV | ~69 mV | ~22 mV |
| panel | | | | |

Table 1 shows simulated results of the voltage difference between adjacent pixels in display panels under different frame rates. In this case, the voltage difference between pixels in the same column can be regarded as coupling noise disclosed above, the display panel 100 shown in FIG. 1 represents an old structure and the display panel 200 shown in FIG. 2 represents a new structure. As shown, in the display panel 100, the voltage difference between adjacent pixels in the lower area is about 91 mV. In the display panel 200, the voltage difference between adjacent pixels in the lower area is lowered to about 44 mV. As the frame rate is lowered to 30 Hz with blanking period is half frame period, the voltage difference between adjacent pixels in the lower area of the display panel 100 is lower to about 69 mV and the voltage difference between adjacent pixels in the lower area of the display panel 200 is lower to about 22 mV.

In view of this, the new pixel structure in the display panel 200 can lower coupling noise (the voltage difference between pixels in the same column) to 44 mV, and further lower it to 22 mV when cooperating with blanking period which is half frame period.

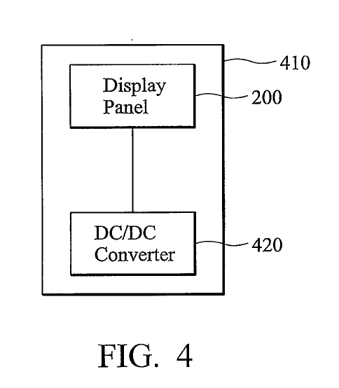

FIG. 4 schematically shows another embodiment of a system for displaying images, implemented here as an electronic device 400, comprising a display panel, such as display panel 200. The electronic device 400 may be a digital camera, a portable DVD, a television, a car display, a PDA, notebook computer, tablet computer, cellular phone, or a display device, etc. Generally, the electronic device 400 includes a housing 410, the display panel 200 and a DC/DC converter 420. The DC/DC converter 420 is operatively coupled to the display panel 400 and provides an output voltage powering the display panel 400 to display images.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for displaying images, comprising:
a display panel comprising:
a plurality of data lines DL(x);
a plurality of gate lines SL(y) perpendicular to the data lines DL(x); and
a pixel array coupled to the data lines and the gate lines, comprising:
a first pixel P(x+1, y) coupled to the gate line SL(y+1) and the data line DL(x+1);
a second pixel P(x+1, y+1) coupled to the gate line SL(y+1) and the data line DL(x+2);
a third pixel P(x, y+1) coupled to the gate line SL(y+2) and the data line DL(x+1); and
a fourth pixel P(x, y+2) coupled to the gate line SL(y+2) and the data line DL(x).

2. The system as claimed in claim 1, wherein the display panel further comprises:
a fifth pixel P(x+2, y+1) coupled to the gate line SL(y+2) and the data line DL(x+3); and
a sixth pixel P(x+2, y+2) coupled to the gate line SL(y+2) and the data line DL(x+2).

3. The system as claimed in claim 1, wherein the pixels in each column in the pixel array display the same color.

4. The system as claimed in claim 3, wherein the, pixels in each row in the pixel array display red, green and blue in sequence.

5. The system as claimed in claim 4, further comprising a scan driver scanning the gate lines in sequence.

6. The system as claimed in claim 5, further comprising a data driver providing display data on the data lines to drive the pixels.

7. The system as claimed in claim 1, wherein the display panel is a liquid crystal display panel, an original light emitting display panel, or a plasma display panel.

8. The system as claimed in claim 1, further comprising an electronic device, wherein the electronic device comprises:
the display panel; and
a DC/DC converter coupled to the display panel and operative to power the display panel.

9. The system as claimed in claim 8, wherein the electronic device is a digital camera, a portable DVD, a television, a car display, a PDA, a display monitor, a notebook computer, a tablet computer, or a cellular phone.

10. A system for displaying images, comprising:
a display panel comprising:
first and second data lines;
a first gate line perpendicular to the first and second data lines; and
first and second pixels disposed in the same column, displaying the same color, wherein the first and second pixels are both coupled to the first gate line and receive display data on the first and second data lines respectively.

11. The system as claimed in claim 10, wherein the display panel further comprises a third pixel disposed in the same column with the first and second pixels, coupled to a second gate line and the first data line.

12. The system as claimed in claim 10, wherein the first and the second pixels are disposed between the first and the second data lines.

13. The system as claimed in claim 11, wherein the first and second pixels receive display data with different polarities on the first and second data lines respectively in the same scan period.

14. The system as claimed in claim 13, wherein the first and third pixels receive display data with the same polarities on the first data line in the different scan period.

15. The system as claimed in claim 10, wherein the display panel is a liquid crystal display panel, an original light emitting display panel, or a plasma display panel.

16. The system as claimed in claim 10, further comprising an electronic device, wherein the electronic device comprises:
the display panel; and
a DC/DC converter coupled to the display panel and operative to power the display panel.

17. The system as claimed in claim 16, wherein the electronic device is a digital camera, a portable DVD, a television, a car display, a PDA, a display monitor, a notebook computer, a tablet computer, or a cellular phone.

18. A driving method of a system for displaying images, comprising:
scanning gate lines in sequence and providing display data to data lines in an effective display period in a frame period based on column inversion; and
electrically coupling the data lines to a common voltage in a blanking period of the frame period, wherein the ratio of the blanking period to the frame period exceeds 5%.

19. The system as claimed in claim 19, wherein the ratio of the blanking period to the effective display period is 1:1.

20. The system as claimed in claim 18, wherein the ratio of the blanking period to the frame period exceeds 50%.
